(19) United States
(12) Patent Application Publication
(10) Pub. No.: US 2005/0079324 A1
(43) Pub. Date: Apr. 14, 2005

(54) Method of making retroreflective material

(76) Inventors: Dale H. Haunschild, Hudson, WI (US); Larry K. Stump, Hudson, WI (US); John L. Ethen, Oakdale, MN (US); Mark D. Zender, Mahtomedi, MN (US)

Correspondence Address: 3M INNOVATIVE PROPERTIES COMPANY, PO BOX 33427, ST. PAUL, MN, 55133-3427, US

(21) Appl. No.: 10/684,239

(22) Filed: Oct. 13, 2003

(51) Int. Cl. B32B 1/00

(52) U.S. Cl. 428/143; 428/174; 428/172

(57) ABSTRACT

The present invention relates to a method of making a retroreflective material comprising enclosed-lens retroreflective sheeting and articles. The articles are particularly useful for pavement markings.

### FIELD OF THE INVENTION

The present invention relates to a method of making a retroreflective material comprising enclosed-lens retroreflective sheeting and articles. The articles are particularly useful for pavement markings.

### BACKGROUND OF THE INVENTION

U.S. Pat. No. 6,127,020 describes a method of making a retroreflective marking material, the method has the steps of: (a) providing an enclosed-lens retroreflective sheet having a top surface and a bottom surface and comprising a cover layer and a monolayer of retroreflective elements; (b) applying a conformance layer to the bottom surface of the retroreflective sheet; and (c) laminating a configuration member to the conformance layer thereby creating first portions and second portions in the sheet, the first portions being arranged in an upwardly contoured profile and the second portions being arranged in a lower, substantially planar position. U.S. Pat. No. 6,303,058 describes a method of making a retroreflective article. The claimed method comprises (a) providing a substantially continuous, longitudinally extending retroreflective base sheet comprising a cover layer and a plurality of retroreflective elements, said base sheet having a retroreflective top surface and a bottom surface; (b) creating a plurality of cavities on said bottom surface of said base sheet without substantially stretching it to yield (i) first portions extending generally perpendicular to the base sheet, said first portions having retroreflective elements arranged in an upwardly contoured profile and (ii) second portions having retroreflective elements arranged in a substantially planar position; and (c) applying a filling material into said cavities to retain in place said first portions.

Although the art describes methods of making retroreflective materials comprising an enclosed-lens retroreflective sheet on the viewing surface, industry would find advantage in alternative methods, particularly those methods having increased manufacturing efficiency.

### SUMMARY OF THE INVENTION

The present invention discloses a method of making a retroreflective material comprising providing a conformable base sheet comprising a plurality of protrusions on a major surface, providing an enclosed-lens retroreflective sheeting having a viewing surface and an opposing surface; and bonding the opposing surface of the retroreflective sheeting to the major surface of the base sheet. The enclosed-lens sheeting is preferably bonded to the base sheet in a manner that minimizes the stretching of the sheeting (preferably less than approximately 10% stretching. An adhesive (e.g. pressure sensitive or heat and pressure activated) may be pre-applied to the opposing surface of the enclosed lens sheeting and or the major surface of the base sheet. Alternatively, an adhesive may be applied to either or both surfaces during the bonding process. Preferably, the base sheet and enclosed-lens retroreflective sheeting are bonded in a continuous process.

In one embodiment, the enclosed-lens retroreflective sheeting is provided in a gathered configuration comprising at least one and typically a plurality of recesses. The recess(es) preferably correspond to the protrusions of the base sheet.

Pavement marking materials prepared from the disclosed methods and roadways comprising the pavement marking materials are also described.

### BRIEF DESCRIPTION OF THE DRAWINGS

FIG. 1 is an exemplary schematic view of a method in accordance with the present invention.

FIG. 2 is an exemplary schematic view of an alternative method in accordance with the present invention.

FIG. 3 is an exemplary cross-sectional view of an exemplary retroreflective sheet material that can be produced from the method of the invention.

FIG. 4 is an exemplary top plan view of retroreflective sheet material that can be produced from the method of the invention.

### DETAILED DESCRIPTION OF ILLUSTRATIVE EMBODIMENTS

The subject invention provides a method for manufacturing a retroreflective material. The resulting retroreflective material is particularly well suited for use as a pavement marking strip. The method generally comprises providing a conformable base sheet comprising a plurality of protrusions on a major surface and bonding an enclosed-lens retroreflective sheet to the major surface of the base sheet. “Conformable” refers to the physical property of conforming to irregularities in a surface. As described in U.S. Pat. No. 5,194,113; incorporated herein by reference, conformable marking tapes and thus conformable base layers are capable of being deformed under reasonable forces in order to take on the shape of the road surface irregularities, and thereby allow formation of a good bond to the road surface. By reasonable forces it is meant that after applying the marking sheet to a road surface and tamping it, the marking tape conforms to the road surface. In such an application, the tamped tape substantially replicates the surface texture of the road.

Conformability of the base layer or pavement marking sheet can be evaluated in other ways as well. One simple way is to press a base layer sheet of the material by hand against a complex, rough, or textured surface such as a concrete block or asphalt composite pavement, remove the sheet, and observe the degree to which the surface has been replicated in the sheet. Another assessment of the conformance may be obtained as follows. First, the force required to deform the sheet material is measured. Second, a portion of the induced strain is relieved. Finally, the retractive force remaining in the material at the reduced strain level is measured. A specific example of this process would be to deform a sample to 115% of its original length by stretching the sample at a strain rate of 0.05 sec⁻¹ and measuring the stress at 115% deformation, release the strain at the same rate, allow the material to return to 110% of its original length, and measure the retractive force. This measurement may be made using a standard tensile testing apparatus such as, for example, the servohydraulic tensile testers available from MTS Systems Corporation of Minneapolis, Minn. Preferred comformable base layer materials exhibit a force to deform the sample to 115% of its original length of less than 35 NT per cm width (20 lbs per inch width), and a retractive force at a subsequent 110% deformation of less than 14 NT per cm width (8 lbs per inch width), although lesser forces are even more preferred. Other measures of conformability such as described in U.S. Pat. No. 5,194,113, and may also be used to evaluate the conformance of the base layer or pavement marking sheet (e.g. tape).

By bonding a conformable base layer comprising protrusions to an enclosed-lens sheeting, the article is advantageously free of a separate (e.g. aluminum) conformance layer.

Enclosed-lens retroreflective sheeting generally takes the form of a substantially continuous, longitudinally extending retroreflective sheeting having a cover layer and a plurality of retroreflective elements. In contrast to exposed-lens retroreflective sheeting, the retroreflective elements are enclosed by the cover layer. The retroreflective elements may be in the form of cube-corner elements, optionally having a specular reflector on the cube-corner element faces. Alternatively, the retroreflective elements may be in the form of microspheres, with a reflector in optical association with the microspheres. The cover layer is preferably polymeric, may optionally be colored with, for example, a fluorescent colorant, and is light transmissible, meaning that the cover layer transmits at least a portion of incident light in the visible spectrum of about 400 to 700 nanometers wavelength. Depending on its construction, enclosed-lens sheeting may also be referred to as “encapsulated-lens” or “embedded-lens” sheeting.

The enclosed-lens retroreflective sheet may be bonded to the base layer in any manner that imparts the retroreflective material with sufficient durability such that it does not delaminate appreciably to impair substantially its retroreflective properties during its intended duration of use. Suitable bonding methods include those employing heat, pressure, an adhesive composition, and combinations thereof.

The enclosed-lens retroreflective sheeting is preferably bonded to the base sheet in a manner that minimizes the stretching of the sheeting. Excessive stretching of the sheeting may tend to detract from the intended retroreflected brightness of the sheeting. Accordingly, it is generally preferred that the length of the sheeting after bonding to the base sheet be no more than approximately 10% greater than its initial length before the bonding process. The coefficient of retroreflected luminance after bonding generally should be at least about 75 mcd/m²/lux, preferably at least 100 mcd/m²/lux, and more preferably at least 200 mcd/m²/lux, according to ASTM D 4061-95 for an entrance angle of 89.7° and an observation angle of 0.25°, with incident light from any direction. Advantageously, the marking material exhibits such retroreflected brightness under both wet and dry conditions.

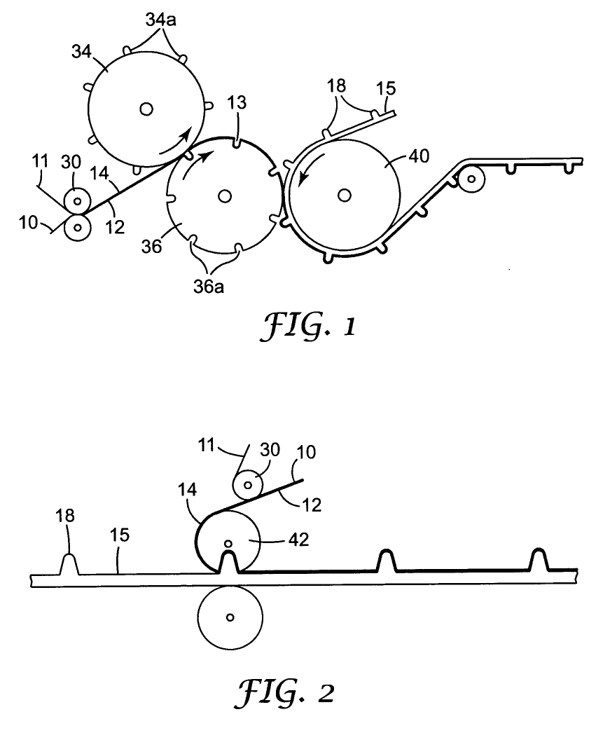

In one illustrative method depicted in FIG. 1, the enclosed-lens retroreflective sheeting 10 is fed into a pair of rolls 34 and 36 such that the retroreflective sheet's viewing surface 12 is in contact with roll 36. The enclosed-lens retroreflective sheeting may be pre-manufactured comprising a pressure sensitive adhesive layer 14 covered by a release liner 11 on its opposing surface. The release liner 11 is removed from the sheeting such as by stripping roller 30 to expose the underlying adhesive layer 14. Roll 34 has a plurality of ridges 34a projecting from its surface. The ridges correspond in dimension to the recesses between protrusions 18 of advancing base sheet 15. Roll 36 has a plurality of grooves 36a corresponding in dimension to the protrusions of advancing base sheet 15. The grooves 36a also correspond in dimension to the plurality of ridges of roll 34. The gathering of the retroreflective sheeting occurs without substantial stretching of the sheeting as previously described. Thus, the grooves 36a are in registration with the ridges 34a such that as the retroreflective sheet 10 is fed into the rolls, the retroreflective sheet is gathered in the grooves to form cavities 13. If desired, the surface of roll 36 can have a series of small holes (not shown) in order that a vacuum can be applied to hold the enclosed-lens sheet against the surface of roll 36. Grooves 36a are also in registration with the protrusions 18 of the advancing base sheet. The grooves 36a may be slightly larger than the protrusions 18 of base sheet 15 to accommodate the volume of adhesive.

In an alternative illustrative method depicted in FIG. 2, enclosed-lens sheeting 10 may be advanced by roll 42 with the viewing surface of the sheeting 12 contacting the roll 42 and the adhesive 14 coated surface of the sheeting facing away from the roll 42. The roll 42 has at least one cavity in registration with the protrusion(s) of base sheet 15. The roll 42 is made of a compliant material such as a rubber. Further, relatively low tension is applied during the advancing of enclosed-lens sheeting 10 such that the sheeting is laminated to the base sheet 15 without substantial stretching of the enclosed-lens sheeting 10.

Alternatively, enclosed-lens sheeting lacking a pre-applied adhesive on its non-viewing surface may be used, regardless of whether adhesive bonding or another form of bonding is used. An adhesive applicator (not shown) may deliver adhesive to the non-viewing surface of the sheeting and or the major surface of the base sheet. For example, with respect to FIG. 1 an adhesive application may be applied in the region of the nip between roll 40 advancing the base sheet and roll 36 advancing and gathering the enclosed-lens sheeting. In doing so, the adhesive is applied immediately prior to contacting the sheets together in a continuous process. Further, a primer also may be applied to the opposing surface of the retroreflective sheet and/or to the major surface of the base sheet. Alternatively or in addition thereto, either surface may be surface treated such as by electrostatic discharge (e.g. corona treated) and/or flame treatment. In the case of thermoplastic base sheet layers, the major surface of the base sheet may be flash heated to soften the surface layer immediately prior to contacting to the enclosed-lens retroreflective sheet as an alternative bonding means.

A variety of adhesive compositions may be used for bonding the base layer to the enclosed-lens sheeting. The adhesive compositions may comprise a wide variety of non-thermoplastic hydrocarbon elastomers, including, natural rubber, butyl rubber, synthetic polyisoprene, ethylene-propylene rubber, ethylene-propylene-diene monomer rubber (EPDM), polybutadiene, polyisobutylene, poly(alpha-olefin) and styrene-butadiene random copolymer rubber. Such elastomers may be combined with tackifiers or other optional adjuvants. Examples of useful tackifiers include rosin and rosin derivatives, hydrocarbon tackifier resins, aromatic hydrocarbon resins, aliphatic hydrocarbon resins and terpene resins. Preferably the tackifier comprises from about 10 to 200 parts by weight per 100 parts by weight of the elastomer. Such adhesive composition are preferably prepared according to the method described in U.S. Pat. Nos. RE 36,855 and 6,116,110, which are each incorporated herein by reference.

A preferred adhesive composition is a heat and pressure activated adhesive, such as those described in U.S. Pat. No. 2,726,222. Other preferred adhesive compositions include pressure sensitive adhesive compositions such as those described in the art for bonding a pavement marking strip to a pavement surface. An acrylic (e.g. acrylate based) pressure sensitive adhesive composition, such as those described in RE 24,906 and WO 98/24978 (which are each incorporated herein by reference) is an exemplary preferred adhesive. Preferred acrylate based adhesive compositions may include, for example, four types of compositions: i) compositions comprising about 50 to 70 weight-% polyoctene and about 30 to 40 wt-% tackifier; ii) compositions comprising about 60 to 85 wt-% isooctyl acrylate, about 3 to 20 wt-% isobomyl acrylate, about 0.1 to 3 wt-% acrylic acid and about 10 to 25 wt-% tackifier; iii) compositions comprising about 40 to 60 wt-% polybutadiene and about 40 to 60 wt-% tackifier; and iv) compositions comprising 40 to 60 wt-% natural rubber and about 40 to 60 wt-% tackifier.

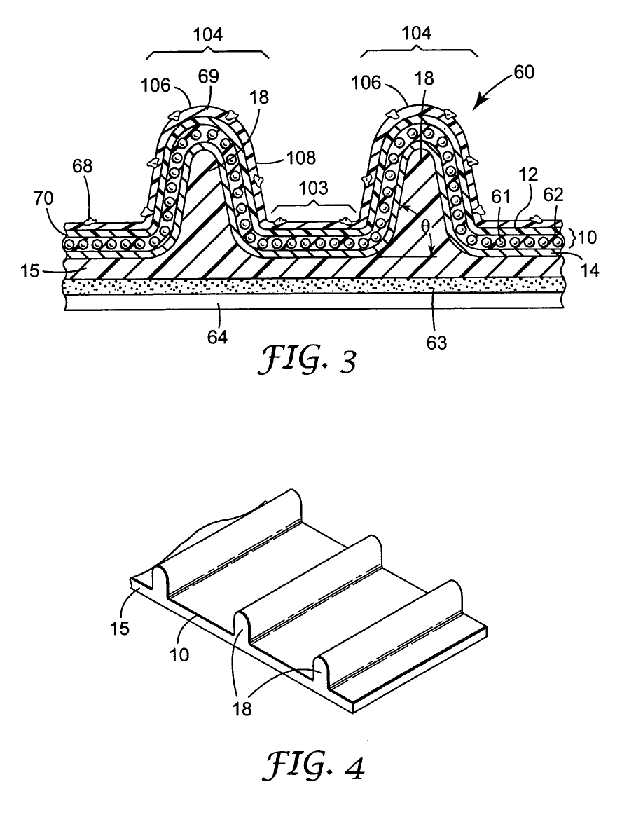

An exemplary cross-sectional view of retroreflective material 60 resulting from the method described herein is depicted in FIG. 3. FIG. 4 depicts such retroreflective material in plan view. Base sheet 15, having protrusions 18, is bonded to enclosed-lens sheeting 10 by means of adhesive 14. Although a microsphere-based enclosed-lens sheeting having a monolayer of reflective elements 61 (e.g. glass or glass-ceramic beads) at least partially embedded in binder layer 62 and cover layer 70 is depicted, cube-corner enclosed-lens sheeting may also be employed. The retroreflective material 60 includes a plurality of upwardly contoured, elevated, and profiled first portions, referred to herein as “protrusions” 104, each with a top surface 106 and a side surface 108. The protrusions 104 typically have a height of at least 0.5 mm. Preferably the height is at least about 1 mm (e.g. 2 mm, 3 mm). Typically the height ranges up to about 4 mm. The retroreflective material 60 has recesses 103 between protrusions. Preferably to minimize shadowing, the ratio of the width of the recess to the height of the protrusion is at least about 5 to 1 (e.g. 10 to 1, 15 to 1, 20 to 1, 30 to 1). More preferably, the ratio of the width of the recess to the height of the protrusion is about 40 to 1. In the method described herein, the spacing and dimensions of the cavities of either roll 36 or 42, and likewise ridges 34a and protrusions 18 of the base sheet, are formed to provide the desired ratio.

As shown in the embodiment depicted in FIG. 3, the side surfaces 108 meet the top surface 106 at a rounded top portion. The side surfaces 108 meet the front recess 103 forming an angle of approximately 30-90° (e.g. 45-90°) at the intersection, depending on the angular brightness of the enclosed-lens sheeting being formed. The tops of the protrusions typically define a plane substantially parallel to the surface of the sheet. Although preferred for ease in manufacturing, the protrusions need not necessarily be regularly shaped, regularly sized, or regularly spaced apart.

The retroreflective material manufactured from the methods described above may further comprise optional materials or layers. Such optional materials or layers are typically pre-applied to either the base sheet and/or the enclosed-lens retroreflective sheeting. Alternatively, however, such additional layers may be provided and bonded in-situ in the same continuous process as the bonding of the enclosed-lens sheeting to the base sheet. The base sheet may further includes a pressure sensitive adhesive 63 covered by a release liner 64 on the non-viewing surface of the retroreflective material. Further, the viewing surface of the retroreflective material also may contain skid particles 68 partially embedded in protective coating 69.

Base sheet materials suitable for pavement marking strips are known. An exemplary base sheet material having horizontal protrusions, and methods of producing that base material, is described in, for example, U.S. Pat. No. 4,388,359; incorporated herein by reference. The base sheet material may comprise a thermoplastic material or a substantially non-crosslinked elastomer precursor. The elastomer precursor may partially crosslink when thermally blended with optional ingredients, such as fibers, as well as when extruded or calendared into a sheet. Although the elastomer precursors are typically initially thermally blended, due to the crosslinking such compositions are characteristically non-thermoplastic once formed into a sheet. The base material may further include fibers, including ceramic fibers as described in U.S. patent application Ser. No. 10/078771, filed Feb. 18, 2002 and incorporated herein by reference. Non-thermoplastic organic fibers, such as polyester fibers, polyolefin fibers, and mixtures thereof, may also be included.

The polymeric material provides viscoelastic properties, which permit absorption of the forces and pressures of wheeled road traffic without creating internal forces that tend to remove the marking from the roadway. Acrylonitrile-butadiene polymers are especially desirable elastomer precursors because they offer a high degree of oil resistance. Other useful non-crosslinked elastomer precursors that offer good oil resistance include neoprene and polyacrylates. Natural rubber and styrene-butadiene polymers may also be used. Extender resins, preferably halogenated polymers such as chlorinated paraffins, but also hydrocarbon resins or polystyrenes, are preferably included with the non-crosslinked elastomer precursor ingredients. Such extender resins are miscible with, or form a single phase with, the elastomer precursor ingredients. Such extender resins may account for up to about 20% by weight, and preferably about 10 weight-% of the pavement marking composition of the invention.

U.S. Pat. No. 5,536,569 (Lasch et al.), incorporated herein by reference, describes preferred thermoplastic materials. Representative acid containing ethylene copolymers include ethylene acrylic acid (EAA) copolymers and ethylene methacrylic acid (EMAA) copolymers, mixtures of EAA and EMAA, and ionicly cross-linked EMAA. Alternative thermoplastic materials, although less preferred for the topmost layer, include ethylene n-butyl acrylate (EnBA), ethylene vinyl acetate (EVA) and blends thereof, as well as polyolefins.

Particularly preferred thermoplastic materials include EMAA polymer, commercially available from the E.I. Dupont de Nemours and Company (Dupont) of Wilmington, Del. under the trade designation “NUCREL,” and ionically cross-linked ethylene methacrylic acid (EMAA) ionomers, also available from Dupont under the trade designation “Surlyn”.

Fillers are typically included in the base layer. Fillers can advantageously enhance properties such as reinforcement, extension, surface hardness, and abrasion resistance. Platelet fillers (i.e., fillers having a plate-like shape, such as magnesium silicate, talc, or mica), have been found to contribute the best abrasion resistance and downweb strength properties. Also, the platelet fillers make the sheet material harder. In addition, the platelet fillers have a high ratio of surface area to volume, which enhances their reinforcing ability. Other fillers, such as needle-type or bead-type fillers, may be employed instead of or in addition to low concentrations of platelet fillers. The amount of filler included in the sheet material of the invention varies with the kind of filler used.

After mixing, the composition of the base sheet is processed on calendaring rolls where the composition forms a smooth band and is then processed into thin sheets of the desired thickness. Generally, sheets are formed having a thickness of at least about ¼ millimeter, and preferably of at least about 1 millimeter. Generally, the sheets are less than about 5 millimeters thick, and preferably less than about 3 millimeters thick.

To create protrusions in the base sheet material, preferably the sheet is embossed, as described in U.S. Pat. No. 4,988,541, incorporated herein by reference. For the embodiment shown in FIG. 3, the protrusions project from and are integral with the base sheet. Accordingly, the protrusions and base sheet are comprised of the same material. However, the protrusions may be created by other means and/or the protrusions may be comprised of a different material than that of the base sheet.

A variety of enclosed-lens retroreflective sheeting are known. A preferred cube-corner based retroreflective enclosed-lens sheeting is described in U.S. Pat. No. 5,450,235 (Smith et al.). Smith describes a flexible cube-comer base sheet having a body portion and a multitude of cube-corner elements that project from a rear side of the body portion. The body portion includes a cover layer (referred to in the patent as a “body layer”) that contains a light-transmissible polymeric material having an elastic modulus less than 7×10⁸ Pascals. The cube-corner elements contain a light-transmissible polymeric material having an elastic modulus greater than 16×10⁸ Pascals. Smith teaches that the cube-corner elements may be formed from, for example, polycarbonate. A seal film may be attached to portions of the cube-corner elements. The seal film maintains an air interface at the backside of the cubes to enhance retroreflectivity. This construction is typically referred to as an “encapsulated lens cube-corner” base sheet.

An “encapsulated-lens cube-corner” base sheet generally comprises a body portion having a cover layer and a plurality of cube-corner elements having faces projecting from the base of the cover layer, and a sealing film attached to portions of cube-corner elements' faces to create an air interface between the sealing film and the elements. In contrast, “an embedded cube-corner base sheet” typically uses no sealing film. The base sheet comprises a body portion having a cover layer and multitude of cube-corner elements that project from the rear side of the body portion. The elements' faces are coated with a specular reflective layer, such as aluminum or silver metal. U.S. Pat. No. 5,691,846 (Benson Jr. et al.) discloses an ultra-flexible composite sheeting having an array of cured microstructure cube-corner elements bonded to a cover layer (referred to in the patent as an “overlay film”).

Various microsphere-based retroreflective sheets may be used in the method described herein. Illustrative encapsulated-lens sheeting designs are disclosed in U.S. Pat. No. 4,025,159 (McGrath). An “encapsulated-lens microsphere-based” base sheet includes a layer of microspheres at least partially embedded in a binder containing specular or diffuse reflecting materials, so that the when the binder is allowed to contact the cover layer, an air interface is formed between the cover layer and the exposed portion of the microspheres. An illustrative example of a commercially available encapsulated-lens base sheet is the “3M Scotchlite High Intensity Flexible Work Zone Sheeting Series 3810” sold by 3M Company of St. Paul, Minn.

Illustrative embedded-lens sheeting is disclosed in U.S. Pat. No. 4,505,967 (Bailey). An “embedded-lens microsphere-based” base sheet includes a layer of microspheres having a space layer on the rear surface, a reflective means in optical association with the rear surfaces of the microspheres, and a cover layer in which the front surfaces of the microspheres are embedded. Illustrative examples of commercially available embedded-lens sheeting include, for example, retroreflective sheeting commercially available from 3M under the trade designation “3M Scotchlite Reflective License Plate Sheeting Series 4780,” “3M Scotchlite Engineer Grade Reflective Sheeting Series 3290,” and “3M Scotchlite Flexible Reflective Sheeting Series 580.”

The cover layer of the enclosed-lens retroreflective sheeting 70 may further include a protective coating 69. The protective coating provides abrasion and dirt resistance. Since the protective coating is disposed on or near the retroreflective surface of the retroreflective sheet, such coating is preferably light transmissible. The protective coating preferably includes ultraviolet light absorbers. The coating may also contain other components, such as fungicides and light transmissible colorants. Illustrative examples of a protective coating include ceramer coatings and polyurethane coatings. Typically, the protective coating is applied to the retroreflective sheet using conventional coating techniques, such as, for example, notch bar coating, spray coating, gravure coating, and knife coating.

Anti-skid particles are a common component of many pavement marking articles. Typically, anti-skid particles can be randomly sprinkled on to the protective layer of the retroreflective sheet while it is uncured. For example, the protective layer solution can be coated onto the base sheet's retroreflective surface and prior to solution drying and curing, the anti-skids particles can be sprinkled onto the wet solution. The weight of the anti-skid particles causes them to sink partially into the uncured coating. As the coating cures, the anti-skid particles become partially embedded in the protective layer.

Polyurethanes protective coatings generally have good adhesion to the anti-skid particles. Preferred urethanes are aliphatic polyurethanes, because they adhere strongly to the base sheet and are resistant to environmental weathering, including dirt build-up and discoloration from exposure to ultraviolet radiation. An illustrative example of a crosslinked water-based polyurethane protective coating is commercially available from Avecia Inc., Wilmington, Del. under the trade designation “NEOREZ R-960” crosslinked with “Neocryl CX100”.

Retroreflective articles produced from the method described herein may be used in a number of different applications, including in wet conditions and where light is incident at high entrance angles. The articles are well suited for use as pavement markings or in horizontal signs. Embodiments of sheeting made by the methods described herein can provide effective retroreflection over wide entrance angles. As a result, when the sheeting is wrapped around an object such as a telephone pole or barrel, the entire surface of the sheeting that is within a motorist's line of sight can provide effective retroreflection, including portions on the surface of the article that are curving away from the motorist. This increases the effective retroreflective area, providing a more visible marking and thereby enhancing safety.

Articles produced from the method of the invention are visible from any direction, as the reflectivity is high regardless of the direction of approach of the viewer to the article. This omni-directional feature makes the invention particularly well suited for horizontal signing applications, intersection markings, etc. where vehicles may approach from a number of angles.

The present invention has now been described with reference to several specific embodiments foreseen by the inventor for which enabling descriptions are available. Insubstantial modifications of the invention, including modifications not presently foreseen, may nonetheless constitute equivalents thereto. Thus, the scope of the present invention should not be limited by the details and structures described herein, but rather solely by the following claims, and equivalents thereto.

1. A method of making a retroreflective material, consisting essentially of:
providing a conformable base sheet comprising a plurality of protrusions on a major surface and an opposing surface;
providing an enclosed-lens retroreflective sheeting having a viewing surface and an opposing surface; and
bonding the opposing surface of the retroreflective sheeting to the major surface of the base sheet.

2. The method of claim 1, wherein the protrusions have a top surface that define a plane.

3. The method of claim 1, wherein the protrusions project from and are integral with the base sheet.

4. The method of claim 1, wherein the enclosed-lens retroreflective sheeting has an initial length before bonding, and an length after bonding no more than 10% greater than its initial length.

5. The method of claim 1, wherein an adhesive layer is provided on the opposing surface of the enclosed lens sheet.

6. The method of claim 5, wherein the adhesive is a pressure sensitive adhesive.

7. The method of claim 5, wherein the adhesive is a heat activated adhesive.

8. The method of claim 1, wherein the enclosed-lens sheeting is laminated to the base sheet.

9. The method of claim 1, wherein the enclosed-lens retroreflective sheeting is provided in a gathered configuration comprising a plurality of cavities.

10. The method of claim 9, wherein the gathered configuration comprises a plurality of cavities corresponding to the protrusions on the base sheet.

11. The method of claim 1, wherein the base sheet and enclosed-lens retroreflective sheeting are bonded in a continuous process.

12. The method of claim 1, wherein an adhesive is applied to at least the major surface of the base sheet, the opposing surface of the enclosed-lens retroreflective sheeting, or combination thereof.

13. The method of claim 12, wherein the adhesive is applied during a continuous process.

14. The method of claim 1, wherein the base sheet comprises a substantially non-crosslinked elastomer precursor.

15. The method of claim 14, wherein the elastomer precursor is selected from the group comprising acrylonitrile-butadiene polymers, neoprene, polyacrylates, natural rubber, and styrene-butadiene polymers.

16. The method of claim 1, wherein the base sheet comprises a thermoplastic material.

17. The method of claim 16, wherein the major surface of the base sheet is heated to soften the surface of the base sheet prior to or during bonding.

18. The method of claim I, wherein the enclosed-lens sheeting comprises a cube-corner based retroreflective sheeting.

19. The method of claim 1, wherein the enclosed-lens sheeting comprises a microsphere-based retroreflective sheeting.

20. A retroreflective article prepared from the method of claim 1.

21. A pavement marking material prepared from the method of claim 1.

22. The pavement marking material of claim 21 wherein the coefficient of retroreflected luminance is at least about 200 mcd/m²/lux, according to ASTM D 4061-95 for an entrance angle of 89.7° and an observation angle of 0.25°, with incident light from any direction.

23. A pavement marking tape prepared from the method of claim 1, further comprising a pressure sensitive adhesive disposed on the opposing surface of the base sheet.

24. A roadway comprising the pavement marking material of claim 23.
